(19) United States
(12) Patent Application Publication
(10) Pub. No.: US 2026/0161013 A1
(43) Pub. Date: Jun. 11, 2026

(54) AERIAL IMAGE DISPLAY DEVICE AND AERIAL IMAGE DISPLAY METHOD

(71) Applicant: NTT, Inc., Tokyo (JP)

(72) Inventors: Motohiro MAKIGUCHI, Tokyo (JP); Ayaka SANO, Tokyo (JP); Takahiro MATSUMOTO, Tokyo (JP); Ryuji YAMAMOTO, Tokyo (JP)

(73) Assignee: NTT, Inc., Tokyo (JP)

(21) Appl. No.: 19/129,025

(22) PCT Filed: Nov. 18, 2022
(86) PCT No.: PCT/JP2022/042892

§ 371 Date: May 12, 2025

(51) Int. Cl. G02B 30/56; G02B 27/28

(52) U.S. Cl. CPC G02B 30/56; G02B 27/283; G02B 27/286

(57) ABSTRACT

An aerial image display device includes a display, a retroreflective material, a retardation plate, a beam splitter, and a polarizing plate. The display, the retroreflective material, and the beam splitter are disposed on an installation bottom surface. The display emits polarized light of a display image that is the basis of an aerial image in accordance with a polarization direction of incident light. The retroreflective material reflects incident light in an incident direction. The beam splitter reflects polarized light of the display image emitted from the display toward the retroreflective material in accordance with the polarization direction of the incident light and has polarized light of the display image reflected by the retroreflective material transmitted therethrough. The polarizing plate is disposed above the installation bottom surface, extends across an imaging plane of the aerial image, and has polarized light transmitted through the beam splitter transmitted therethrough.

### TECHNICAL FIELD

The present invention relates to an aerial image display device and an aerial image display method.

### BACKGROUND ART

Aerial images are real images displayed in a real space and can be viewed by viewers without wearing a device. For this reason, aerial images are used in a variety of applications, including Augmented Reality (AR).

As a method for displaying an aerial image, for example, a method called Aerial Imaging by Retro-Reflection (AIRR) which uses a retroreflective material and a beam splitter has been proposed.

### CITATION LIST

### Non Patent Literature

[NPL 1] Nakajima et al., Evaluation methods of retro-reflector for polarized aerial imaging by retro-reflection, 11th CLEO-PR, pp. 1-2, 2015.

### SUMMARY OF INVENTIO N

### Technical Problem

In the viewing space of aerial images created using AIRR, when there is an object such as a floor or table surface in the field of view of the viewer viewing the aerial image and between the viewer and the aerial image, the light of the aerial image is blocked by the object. Thus, the aerial image viewed by the viewer is partially obstructed.

A main object of the present invention is to provide an aerial image display device which eliminates obstruction of an aerial image mainly due to an object of a horizontal surface such as a floor or table surface in a viewing space.

### Solution to Problem

An aspect of the present invention is an aerial image display device. An aerial image display device includes a display, a retroreflective material, a retardation plate, a beam splitter, and a polarizing plate. The display, the retroreflective material, and the beam splitter are disposed on an installation bottom surface. The display emits polarized light of a display image that is the basis of an aerial image. The retroreflective material reflects incident light in an incident direction. The beam splitter reflects polarized light of the display image emitted from the display toward the retroreflective material in accordance with the polarization direction of the incident light and has polarized light of the display image reflected by the retroreflective material transmitted therethrough. The retardation plate is disposed on a reflective surface side of the retroreflective material and changes the polarized light of the display image reflected by the beam splitter to the polarized light of the display image which is transmitted through the beam splitter. The polarizing plate is disposed above the installation bottom surface, extends across an imaging plane of the aerial image, and has polarized light transmitted through the beam splitter transmitted therethrough.

Another aspect of the present invention is an aerial image display method. The aerial image display method includes: installing, on an installation bottom surface, a display which emits polarized light of a display image that is a basis of an aerial image; installing, on the installation bottom surface, a retroreflective material which reflects incident light in an incident direction; installing, on the installation bottom surface, a beam splitter which reflects polarized light of the display image emitted from the display toward the retroreflective material in accordance with the polarization direction of the incident light, and through which the polarized light of the display image reflected by the retroreflective material is transmitted; disposing, on a light incident side of the retroreflective material, a retardation plate which changes the polarized light of the display image reflected by the beam splitter to the polarized light of the display image which is transmitted through the beam splitter; and disposing, above the installation bottom surface, a polarizing plate through which polarized light transmitted through the beam splitter is transmitted so that the polarizing plate extends across an imaging plane of the aerial image.

### Advantageous Effects of Invention

According to the present invention, an aerial image display device which eliminates obstruction of an aerial image mainly due to an object of a horizontal surface such as a floor or table surface in a viewing space is provided.

### BRIEF DESCRIPTION OF DRAWINGS

FIG. 1 is a diagram showing a basic configuration of an aerial image display device using AIRR.

FIG. 2 is a diagram showing optical properties of a retroreflective material.

FIG. 3 is a diagram showing an example of a large display which is vertically installed on a floor surface.

FIG. 4 shows how a lower part of an aerial image cannot be recognized by a viewer.

FIG. 5 is a plan view of an AIRR-based aerial image display device according to a first embodiment when viewed from above.

FIG. 6 is a perspective view of the aerial image display device of FIG. 5 when viewed obliquely.

FIG. 7 is a diagram showing an optical path for forming an aerial image in the aerial image display device of FIG. 5, developed onto a plane.

FIG. 8 is a plan view of an AIRR-based aerial image display device according to a second embodiment when viewed from a side.

### DESCRIPTION OF EMBODIMENTS

Before describing embodiments of the present invention, a basic configuration of an aerial image display device using AIRR will be described. In the following description, for convenience, the aerial image display device using AIRR will be simply referred to as an aerial image display device.

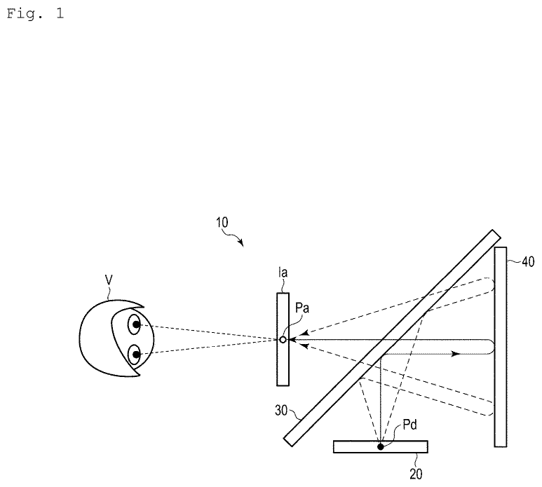

First, the basic configuration of the aerial image display device will be described. FIG. 1 is a diagram showing a basic configuration of an aerial image display device 10. The aerial image display device 10 includes a display 20, a beam splitter 30, and a retroreflective material 40.

The display 20 is a device which displays a display image which is a source of an aerial image on the basis of an input video signal. Moreover, the display 20 emits light of the display image.

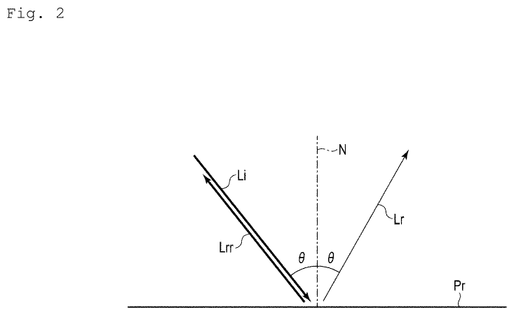

The retroreflective material 40 reflects incident light in the same direction as the light is incident. Here, the optical characteristics of the retroreflective material 40 will be described with reference to FIG. 2. As shown in FIG. 2, it is assumed that incident light Li is incident on a reflecting surface Pr at an incident angle θ. The incidence angle is an angle between the normal N to the reflecting surface Pr and the incident light Li. The incident light Li incident on the reflecting surface Pr is reflected by the reflecting surface Pr and becomes reflected light. When the reflecting surface Pr is a mirror surface, the reflected light Lr reflected by the reflecting surface Pr travels in the opposite direction to the incident light Li at a reflection angle θ equal to the incident angle θ. Note that the reflection angle is an angle between the normal N to the reflecting surface Pr and the reflected light. On the other hand, when the reflecting surface Pr is the surface of the retroreflective material 40, the reflected light Lrr reflected by the reflecting surface Pr travels in the same direction as the incident light Li at a reflection angle θ equal to the incident angle θ.

Referring to FIG. 1 again, the beam splitter 30 will be described. The beam splitter 30 reflects the light of the display image displayed on the display 20 toward the retroreflective material 40 and transmits the light of the display image reflected by the retroreflective material 40.

The divergent light emitted from a pixel Pd of the display 20 is reflected by the beam splitter 30 towards the retroreflective material 40 and enters the retroreflective material 40. As described above, the retroreflective material 40 reflects incident light in the same direction as the light is incident. For this reason, the divergent light incident on the retroreflective material 40 becomes convergent light by being reflected by the retroreflective material 40. The convergent light reflected by the retroreflective material 40 is transmitted through the beam splitter 30 and converges at a point Pa in a space. As a result, the light of the image displayed on the display 20 converges onto a plane including the point Pa to become an aerial image Ia. The aerial image Ia is displayed at a position in which it is plane-symmetrical to the display 20 with respect to the beam splitter 30. The aerial image Ia appears to be floating in the air to a viewer V who views it.

By vertically setting the display 20, the beam splitter 30, and the retroreflective material 40 which constitute the aerial image display device 10 on a horizontal floor surface, it is possible to display an aerial image which stands upright on the floor surface.

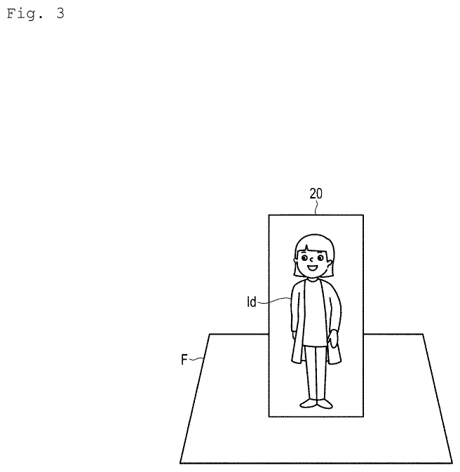

FIG. 3 is a diagram showing an example of a large-sized display 20 which is vertically installed on a horizontal floor surface F. The display 20 is, for example, but not limited to, a large LED display. Here, it is assumed that the display 20 is a large, vertically long display large enough to display a life-size image (Id) of a person.

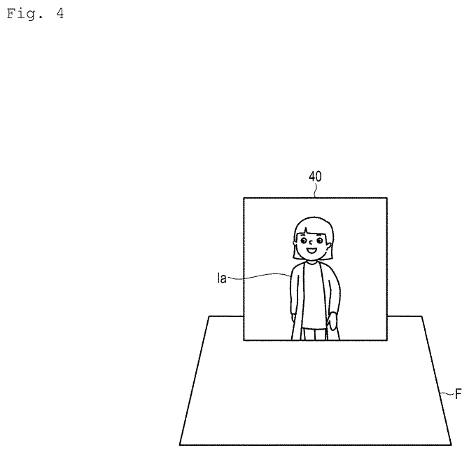

The viewing range of the aerial image Ia is the range connecting the viewpoint of a viewer viewing the aerial image Ia and the reflective surface of the retroreflective material 40. For this reason, the viewing range of the aerial image Ia is limited. Since the light using which the lower part of the aerial image Ia is displayed is blocked due to the bottom surface of the optical system being in the optical path, the lower part of the aerial image Ia cannot be recognized by the viewer. FIG. 4 shows how a lower part of an aerial image Ia cannot be recognized by a viewer.

### First Embodiment

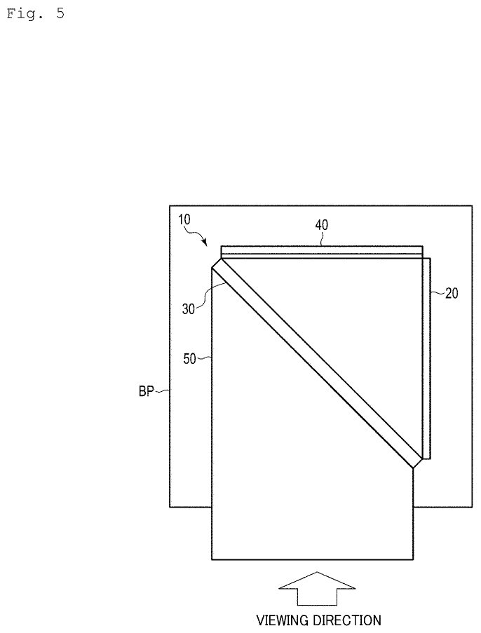

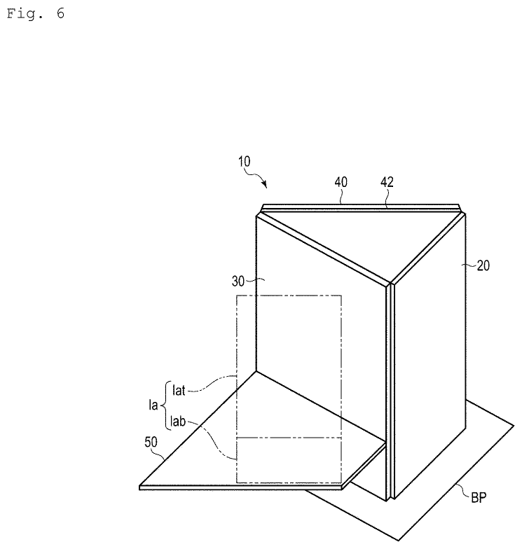

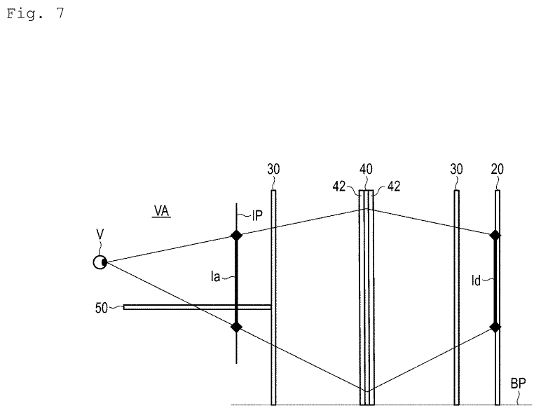

The overall configuration of an aerial image display device 10 according to a first embodiment will be described with reference to FIGS. 5 to 7. FIG. 5 is a plan view of the aerial image display device 10 according to the first embodiment when viewed from above. FIG. 6 is a perspective view of the aerial image display device 10 of FIG. 5 when viewed obliquely. FIG. 7 is a diagram showing an optical path for forming an aerial image in the aerial image display device of FIG. 5, developed onto a plane.

The aerial image display device 10 according to the embodiment has a retardation plate 42 and a polarizing plate 50 in addition to the display 20, the beam splitter 30, and the retroreflective material 40 described in the basic configuration. The display 20, the beam splitter 30, the retroreflective material 40, and the retardation plate 42 are all vertically arranged on a flat installation bottom surface BP. The basic configuration of the display 20, the beam splitter 30, and the retroreflective material 40 is as described above.

The retardation plate 42 is disposed on the reflective surface side of the retroreflective material 40. The retardation plate 42 may be attached to the retroreflective material 40 or may be disposed with a gap therebetween.

The polarizing plate 50 is disposed above an installation bottom surface BP and extends across an imaging plane IP of the aerial image Ia, as shown in FIGS. 6 and 7. The polarizing plate 50 extends from the beam splitter 30 in parallel with the installation bottom surface. The polarizing plate 50 transmits the light which is transmitted through the beam splitter 30.

As shown in FIG. 5, in the aerial image display device 10 according to the embodiment, when viewed from above, the display 20, the beam splitter 30, and the retroreflective material 40 are arranged so that the display 20 and the retroreflective material 40 are perpendicular to each other and the beam splitter 30 forms an angle of 45 degrees with respect to both the display 20 and the retroreflective material 40. Here, the positional relationship between the display 20, the beam splitter 30, and the retroreflective material 40 is not limited to this.

In the embodiment, the display 20 emits polarized light as the light of the display image Id. Here, the light of the display image Id is the light using which the aerial image Ia is displayed. That is to say, although the term “light of a displayed image” and the term “light displaying an aerial image” are used in this specification in some cases, the two terms have the same meaning. Furthermore, the polarized light is classified according to the difference in the trajectory of the apex of the vibration of the electric field vector when viewed from behind in the direction in which the light travels. Hereinafter, the locus described by the apex of the vibration of the electric field vector will be referred to as the polarization direction for convenience.

The beam splitter 30 is an optical element which reflects or transmits incident light in accordance with the polarization direction of the incident light. For example, the beam splitter 30 may be composed of a reflective polarizer, a wire grid, or the like.

The retardation plate 42 converts the light reflected by the beam splitter 30 into light which is transmitted through the beam splitter 30. The retardation plate 42 is a quarter wave plate.

For example, the display 20 emits linearly polarized light whose polarization direction is perpendicular to the installation bottom surface BP. For convenience, in the following description, linearly polarized light whose polarization direction is perpendicular to the installation bottom surface BP is referred to as vertically linearly polarized light, and linearly polarized light whose polarization direction is horizontal to the installation bottom surface BP is referred to as horizontally linearly polarized light.

The beam splitter 30 reflects the vertically linearly polarized light and transmits the horizontally linearly polarized light. The retardation plate 42 changes the vertically linearly polarized light into the horizontally linearly polarized light. The polarizing plate 50 transmits the horizontally linearly polarized light. The polarizing plate 50 constitutes the floor of a viewing space VA for the viewer of the aerial image.

The imaging optical path of the aerial image Ia will be described below with reference to FIG. 7. The display 20 displays a display image Id which is the basis of the aerial image Ia. Moreover, the display 20 emits the vertically linearly polarized light that is the light of the display image Id. The vertically linearly polarized light emitted from the display 20 is reflected by the beam splitter 30 and travels towards the retroreflective material 40. The vertically linearly polarized light is transmitted through the retardation plate 42, becomes circularly polarized light, and enters the retroreflective material 40. The retroreflective material 40 retroreflects circularly polarized light, converting divergent light into convergent light. The circularly polarized light reflected by the retroreflective material 40 is transmitted through the retardation plate 42, becomes horizontally linearly polarized light, and travels toward the beam splitter 30. The beam splitter 30 has incident horizontally linearly polarized light transmitted therethrough. The horizontally linearly polarized light transmitted through the beam splitter 30 is focused on an imaging plane IP to form an aerial image Ia.

A viewer V in a viewing region VA views a part of the aerial image Ia located above the upper surface of the polarizing plate 50 directly and views a part of the aerial image Ia located below the upper surface of the polarizing plate 50 through the polarizing plate 50. Thus, the viewer V in the viewing region VA perceives the horizontal polarizing plate 50 as a black board because it absorbs half of the ambient light, while the light from the aerial image Ia is transmitted through the polarizing plate 50, allowing the viewer V to view the aerial image Ia displayed at a position in which it and the horizontal plane overlap without being blocked. That is to say, the obstruction of the aerial image Ia due to a horizontal plane in the viewing space VA is eliminated.

At this time, when the beam splitter 30 and the polarizing plate 50 have ideal optical characteristics, a portion of the aerial image Ia located above the upper surface of the polarizing plate 50 and a portion of the aerial image Ia located below the upper surface of the polarizing plate 50 can be provided to have the same brightness.

### Second Embodiment

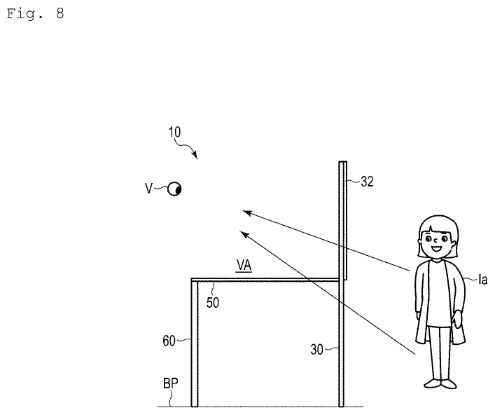

An aerial image display device 10 according to a second embodiment will be described with reference to FIG. 8. FIG. 8 is a plan view of the aerial image display device 10 according to the second embodiment when viewed from a side.

In the aerial image display device 10 of the embodiment, the polarizing plate 50 is supported by a support 60 provided on an installation bottom surface BP and forms the top of a table placed in the viewing space VA for a viewer V of an aerial image Ia.

Furthermore, the aerial image display device 10 further includes a polarizing plate 32 attached to a portion of the beam splitter 30 located above the polarizing plate 50. The polarizing plate 32 is a linear polarizer having a transmission axis thereof coincident with a transmission axis of the beam splitter 30.

In this configuration, the imaging light of the portion of the aerial image Ia located below the polarizing plate 50 is transmitted only through the beam splitter 30 to form an image and the imaging light of the portion of the aerial image Ia located above the polarizing plate 50 passes both the beam splitter 30 and the polarizing plate 32 to form an image.

Even when the polarizing plate 50 does not have ideal optical properties, such as slightly absorbing light in the transmission axis direction, by providing the polarizing plate 32, the portion of the aerial image Ia located above the polarizing plate 50 and the portion of the aerial image Ia located below the polarizing plate 50 can have the same brightness.

### REFERENCE SIGNS LIST

10 Aerial image display device
20 Display
30 Beam splitter
32 Polarizing plate
40 Retroreflective material
42 Retardation plate
50 Polarizing plate
60 Support
BP Installation bottom surface
Id Display image
Ia Aerial image

1. An aerial image display device, comprising:
a display at an installation bottom surface to emit polarized light of a display image that is a basis of an aerial image;
a retroreflective material at the installation bottom surface to reflect incident light in an incidence direction;
a beam splitter at the installation bottom surface, which reflects polarized light of the display image emitted from the display toward the retroreflective material in accordance with the polarization direction of the incident light, and through which the polarized light of the display image reflected by the retroreflective material is transmitted;
a retardation plate which is disposed on a reflective surface side of the retroreflective material and changes the polarized light of the display image reflected by the beam splitter to the polarized light of the display image which is transmitted through the beam splitter; and
a polarizing plate which is disposed above the installation bottom surface, which extends across an imaging plane of the aerial image, and through which polarized light transmitted through the beam splitter is transmitted.

2. The aerial image display device according to claim 1, wherein:
the polarizing plate extends from the beam splitter in parallel with the installation bottom surface.

3. The aerial image display device according to claim 2, wherein:
the polarizing plate is a floor of a viewing space for a viewer of the aerial image.

4. The aerial image display device according to claim 2, wherein:
the polarizing plate is at a table top placed in a viewing space for a viewer of the aerial image.

5. The aerial image display device according to claim 1, wherein:
the display emits linearly polarized light whose polarization direction is perpendicular to the installation bottom surface, and
the retardation plate is a quarter wave plate.

6. The aerial image display device according to claim 1, further comprising:
a polarizing plate attached to a portion of the beam splitter located above the polarizing plate.

7. An aerial image display method, comprising:
installing, on an installation bottom surface, a display which emits polarized light of a display image that is a basis of an aerial image;
installing, on the installation bottom surface, a retroreflective material which reflects incident light in an incident direction;
installing, on the installation bottom surface, a beam splitter which reflects polarized light of the display image emitted from the display toward the retroreflective material in accordance with the polarization direction of the incident light, and through which the polarized light of the display image reflected by the retroreflective material is transmitted;
disposing, on a light incident side of the retroreflective material, a retardation plate which changes the polarized light of the display image reflected by the beam splitter to the polarized light of the display image which is transmitted through the beam splitter; and
disposing, above the installation bottom surface, a polarizing plate through which light transmitted through the beam splitter is transmitted so that the polarizing plate extends across an imaging plane of the aerial image.
